(19) United States
(12) Patent Application Publication
(10) Pub. No.: US 2025/0202161 A1
(43) Pub. Date: Jun. 19, 2025

(54) Electrical plug connector and plug connector system

(71) Applicant: HARTING Electric Stiftung & Co. KG, Espelkamp (DE)

(72) Inventor: Jens KRAUSE, Espelkamp (DE)

(21) Appl. No.: 18/917,797

(22) Filed: Oct. 16, 2024

(30) Foreign Application Priority Data
Dec. 13, 2023 (DE) 102023134975.9

(51) Int. Cl. H01R 13/621; H01R 13/502; H01R 13/52; H01R 107/00

(52) U.S. Cl. CPC H01R 13/621; H01R 13/502; H01R 13/5213; H01R 13/5219; H01R 2107/00

(57) ABSTRACT

An electrical plug connector for receiving and connecting at least one coaxial line to a mating plug connector, wherein the plug connector has a plug connector housing and a line fastening arranged thereon is disclosed. The line fastening interacts, to provide a seal against foreign media and to fasten the line, with a sheath of the line, wherein a contact element arranged in the plug connector is electrically conductively connected to an inner conductor of the line. An outer conductor of the line is electrically conductively connected to the plug connector housing in the interior of the plug connector housing. The inner conductor is received in force-fitting fashion in the interior of the plug connector housing by at least one fixing device.

The invention is based on an electrical plug connector and a plug connector system, having this plug connector.

Plug connector systems of this type are required either to transmit signals and data ideally with no electromagnetic interference or to reduce the influence on other electrical and/or electronic appliances in the case of high current transmission. Particular demands can thus be placed on the robustness of the housing and of the secure electrical connection for environmental reasons. Particular attention is paid in the field of rail vehicles to the compact and at the same time robust design of the plug connectors and plug connector systems having these plug connectors.

### BACKGROUND OF THE INVENTION

CN 206 516 824 U discloses a comparable plug connector, used in a plug connector system which is designed for use in a harsh environment and can be used for fastening the components to a mounting rail both inside and outside a device, preferably of a high-speed train.

It has been shown to be disadvantageous in the case of such plug connector systems for connecting coaxial cables that, in particular when shielded electrical conductors are used, a regular line fastening, usually implemented by cable glands known in the prior art, is, in the case of the electrical conductors used, insufficient to secure the conductors and the contacts connected thereto against vibration, rotation and tensile forces. This problem

### SUMMARY OF THE INVENTION

The object of the invention consists in providing a plug connector which enables improved accommodation of coaxial lines.

A further object of the invention is the disclosure of a plug connector system which improves the accommodation of coaxial lines by using the plug connector according to the invention.

The invention is based on an electrical plug connector for receiving and connecting at least one coaxial line to a mating plug connector, wherein the plug connector has a plug connector housing and a line fastening arranged thereon. The line fastening interacts, to provide a seal against foreign media and to fasten the line, with a sheath of the line, wherein a contact element arranged in the plug connector is electrically conductively connected to an inner conductor of the line. An outer conductor of the line is electrically conductively connected to the plug connector housing in the interior of the plug connector housing. The inner conductor is received in force-fitting fashion in the interior of the plug connector housing by at least one fixing device. The inner conductor is here preferably fixed on a separating layer surrounding it. Alternatively, the fixing device receives the inner conductor in a stripped state.

The terms “plug connector” and “mating plug connector” can in principle be used synonymously and have been chosen to make it easier to distinguish between them. Components of the same or different type can here of course be used in the different plug connectors and nevertheless be described appropriately with the same terms.

A “line fastening” is to be understood as an apparatus which retains and fastens the coaxial line at least on one sheath. The line fastening is furthermore preferably designed to protect the plug connector housing from the penetration of foreign media, for example dirt, dust and/or fluids. Such line fastenings are also referred to as cable glands. The line fastening is furthermore employed for strain relief. As the name suggests, the line is thus protected or relieved in particular from inadvertent strain from tension but also compression, vibration and to a certain degree also from rotation.

The term “contact element” first means a contact element configured as a socket contact. The contact element can also be configured as a pin contact. A contact element can moreover be formed as a knife contact. Corresponding therewith, a contact element can be provided as a spring contact. In a skilful way, a contact element is formed as part of an identical-pair contact, i.e. as a contact which is configured so that it can be connected to a second contact of the same design.

A “fixing device” is to be understood as a component which is designed to fasten at least a part of the inner conductor inside the connector insertion module. In this way, the line fastening is extended and improved. Improved protection from movements such as being pulled, compressed, rotated and vibrated is furthermore achieved herewith. In the case of coaxial lines, the inner conductor, also referred to as the middle conductor or core, is encapsulated in a dielectric separating layer. The separating layer separates the inner conductor from the outer conductor. For reasons of improved flexibility, the inner conductor is often incorporated movably in the separating layer. The inner conductor is particularly secured by the fixing device. This additional security is advantageous in the case of core cross sections of 6 mm² and more because an inner conductor with such a core cross section is capable of damaging or even destroying contact bushings and/or contact elements in the case of excessive strain. The additional security is particularly advantageous in the case of core cross sections that is desirable and expedient in particular when supplying power to drives, especially in the field of rail vehicles. Core cross sections can in these fields be equal to or greater than 20 mm², often equal to or greater than 50 mm², also equal to or greater than 95 mm², and in theory even equal to or greater than 240 mm².

The plug connector according to the invention is therefore particularly suitable for receiving lines for the transmission of high electrical currents and/or high electrical voltages and for protecting them by the fixing device from damage.

A “high electrical current” means a current strength of over 50 amperes. In particular, it means a current strength of over 200 amperes. Very particularly, it means a current strength of over 500 amperes. A current strength of equal to or greater than 1000 amperes is also conceivable.

The term “high electrical voltage” is to be understood as a voltage of over 1 kilovolt. In particular, it means a voltage of over 10 kilovolts. Very particularly, it means a voltage of over 15 kilovolts. A current strength of equal to or greater than 25 kilovolts is also conceivable.

A further embodiment provides that the fixing device has at least one fixing element and one clamping element and the clamping element has at least one conductor bushing. A fixing element preferably means a component which is configured to connect and fasten the clamping element.

A “clamping element” is to be understood as a component which receives the line, in particular the inner conductor of the line, in such a way that movement of the inner conductor is reduced and preferably prevented. Especially pulling movements, but also compression movements of the inner conductor on the contact element are to be prevented as a result. Vibrational and rotational movements are furthermore to be reduced and ideally prevented.

A particularly robust embodiment provides that the fixing element has at least one engagement form and the clamping element has at least one engagement element, which are in engagement in the assembled state. In a similar fashion to the terms plug connector and mating plug connector, the terms “engagement form” and “engagement element” are used synonymously within the sense of the invention and are preferably employed for easier readability and assignment. Thus, both terms can represent elements which correspond with each other or can be brought into engagement. Grooves and tongues are preferably employed here as elements, wherein each one of the said elements, a groove or a tongue, is arranged on the clamping element and the element which can be brought into engagement therewith, a tongue or a groove, is arranged on the fixing element. The fixing element preferably has an opening into which a moulded part of the clamping element is introduced. Particularly advantageously, provided on the fixing element is a through opening into/through which an approximately congruent moulded part of the clamping element projects at least partially or from which it projects. Very particularly preferably, the fixing element is configured with a slot or a slit into which a fundamentally congruent projection of the clamping element engages.

In one embodiment, associated with the plug connector housing is a housing cover which is configured with at least one sealing element to receive the line fastening and to protect the plug connector from the penetration of foreign media. In this way, the use of the plug connector system can be provided effectively and securely outdoors, in particular on the outside of a rail vehicle.

In a further embodiment, the housing cover is configured with at least four fastening forms for fastening to the plug connector and at least one through opening which is configured to receive a line fastening. In the simplest form, the fastening forms can already be provided as through openings which enable the fastening of the housing cover to the plug connector by screws, bolts, rivets, latching hooks or similar secure and favourable fastening elements. The originally mentioned through opening can initially be configured as a simple circular outlet through which a line fastening, preferably in the form of a cable gland or a comparable cable fixing means, can be passed and fastened. The through opening can in a skilful fashion be provided with a thread into which a cable gland can be screwed directly. In this way, it is possible to dispense with further fastening means, such as a nut for fastening a cable gland.

In a particularly robust embodiment, it is provided that the housing cover is part of a connector insertion module which furthermore has at least one distance element and one contact region.

A “contact region” means a region of the connector insertion module in which the contact elements of the plug connector are arranged. The contact region can particularly advantageously consist of further components. A contact mount, a contact bushing situated in the contact mount, and the contact element arranged in the contact bushing are principally provided here.

A “connector insertion module” is understood to be a device which is configured so that it can be introduced into the housing of a plug connector and can thus be used to assemble the line, the contact element and the contact bushing in advance, as a result of which final assembly of the plug connector and/or the mating plug connector is particularly simplified.

A “distance element” means in principle a component which is designed to fasten the contact region, consisting of at least the contact mount and/or the contact bushing, at an intended distance from the housing cover or to be fastened thereon.

A “contact bushing” is preferably configured as a device which receives a contact element in an insulating fashion. An alternative term in a comparable application would be an insulating body.

The associated “contact mount” is understood to be a device for receiving the at least one contact bushing which retains the contact bushing and thus the contact elements which it contains in an intended constellation such that the said contact bushing can be inserted into a housing of the plug connector and/or of the mating plug connector.

A skilful embodiment proposes that at least one of the fastening forms is used for receiving the distance element. By way of example, at least two fastening forms preferably arranged diagonally from each other can be used for receiving one distance element each. The described embodiment clearly provides the use of a plug connector system which is as flat as possible and essentially cuboid. Both a firm and secure connection of the connector insertion module and secure assembly of the plug connector or mating plug connector can be ensured by the embodiment.

In a clever embodiment, the distance element has at least one receiving form which is designed to receive the fixing device. In one simple embodiment, a receiving form means an axially peripheral groove. Alternatively, an opening or a through opening can be provided. The opening or through opening can be provided with a thread. Furthermore, an axially peripheral spring, bead or comparable outward-facing form can also be provided as a receiving form.

An expedient embodiment discloses that the fixing element has at least one opening which is brought into engagement with the receiving form of the distance element. In a particularly simple design, the opening is configured as a tongue engaging in a groove. The opening is preferably configured in an approximately U-shape such that engagement in an at least partially cylindrical groove is possible. Other opening shapes, for example C-shaped, V-shaped or other shapes are also conceivable and possibly expedient. An opening is particularly preferably configured as a through opening.

In an ingenious embodiment, the fixing device is formed from at least two essentially identical fixing elements and at least two essentially identical clamping elements, wherein the fixing elements and the clamping elements are connected to one another by at least one connecting element in such a way that a conductor bushing of the clamping element and a conductor bushing of the clamping element receive an inner conductor between them in clamping fashion. In a skilful fashion, two clamping elements are provided here with semicylindrical recesses for the inner conductor and are bordered and clamped/pressed to one another by the fixing elements. A connecting element such as a screw is suitable in a simple fashion for the clamping/pressing. The screw can either engage in a thread which is provided in a fixing element or be provided with a nut in order to obtain the required clamping force/pressure.

A further advantageous embodiment provides that the fixing element is arranged on the receiving form so that it can pivot by means of the opening.

Lastly, an embodiment provides that the distance element is formed from at least two distance pieces, wherein at least one of the distance pieces has a receiving form. In this way, a particularly advantageous connection of the fixing element and distance element can be effected by a distance piece being passed with the receiving form through an opening, configured as a through opening, of the fixing element. The distance piece having the receiving form is then connected to the remaining distance piece and inserted in the connector insertion module as a distance element.

A further object of the invention is achieved by an electrical plug connector system for connecting coaxial conductors, consisting of a plug connector and a mating plug connector corresponding therewith, wherein the plug connector has a plug connector housing and the mating plug connector has a mating plug connector housing. The plug connector and the mating plug connector here have each at least a fixing device for receiving a stripped inner conductor, wherein the fixing devices are arranged in the interior of the plug connector housing and of the mating plug connector housing.

The term “plug connector system” means a system consisting of at least the plug connector which is provided for connection to the mating plug connector. The plug connector system is preferably designed to transmit a high electrical current strength and/or a high electrical voltage. Very particularly preferably, the plug connector system is configured for drives of rail vehicles.

In a clever fashion, an embodiment provides that the plug connector and the mating plug connector each have a connector insertion module which are formed from at least one contact region, the fixing device and a housing cover.

Lastly, an embodiment provides that the connector insertion module has at least one distance element which spaces the housing cover, the fixing device and the contact region apart from one another.

### BRIEF DESCRIPTION OF THE DRAWINGS

An exemplary embodiment of the invention is illustrated in the drawings and will be explained in detail below. In the drawings:

FIG. 1 shows a perspective illustration of a plug connector system;

FIG. 2 shows a perspective illustration of a connector insertion module;

FIG. 3 shows an exploded illustration of a connector insertion module.

### DETAILED DESCRIPTION OF THE INVENTION

The figures contain partially simplified schematic illustrations. In part, identical reference signs are used for the same but possibly non-identical elements. Different views of the same elements could be at different scales. Specifications of directions such as, for example, “left”, “right”, “up” and “down” are to be understood with reference to the respective figure and can vary in the individual illustrations with respect to the object illustrated.

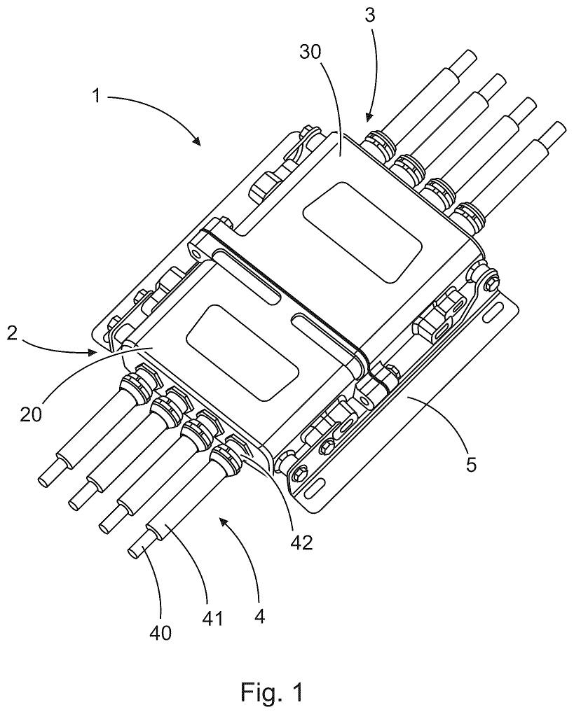

FIG. 1 shows a possible embodiment of a plug connector system 1 according to the invention. Two of the essential components, the plug connector 2 and the mating plug connector 3 coupled thereto, are shown here. Within the sense of the invention, the terms plug connector 2 and mating plug connector 3 are used here essentially synonymously and are referred to correspondingly primarily for improved readability. In principle, properties of the plug connector 2 can also apply for the mating plug connector 3. The plug connector 2 of the plug connector system 1 has a plug connector housing 20. The mating plug connector 3 has a mating plug connector housing 30 which can be connected to the plug connector housing 20. A plug connector 2 can, however, also be configured as a separate plug connector which, for example, directly establishes the electrical connection to an electrical consumer, in particular an electric motor. Both the plug connector 2 and the mating plug connector 3 are designed for connecting lines 4. The lines 4 are here provided at least with an inner conductor 40 and are enclosed with a sheath 41. In order to connect the lines 4 to the plug connector 2 and the mating plug connector 3 so that they are sealed from foreign media, both the plug connector housing 20 and the mating plug connector housing 30 are equipped with line fastenings 42. In FIG. 1, cable glands known in the prior art are used as the line fastening 42. The plug connector housing 20 can be securely connected to the mating plug connector housing 30 with a mounting rail 5. The mounting rail 5 can furthermore be employed to connect the plug connector system 1 to an underlying surface, for example a wall, preferably a wall of a rail vehicle.

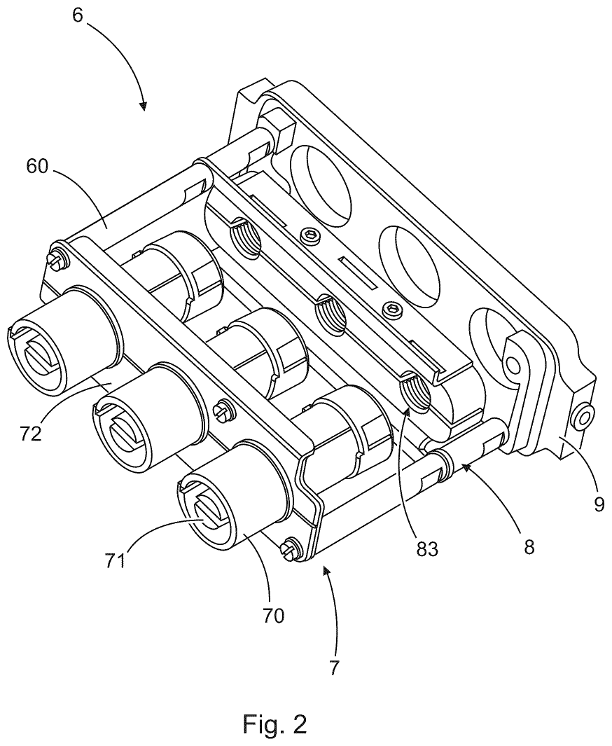

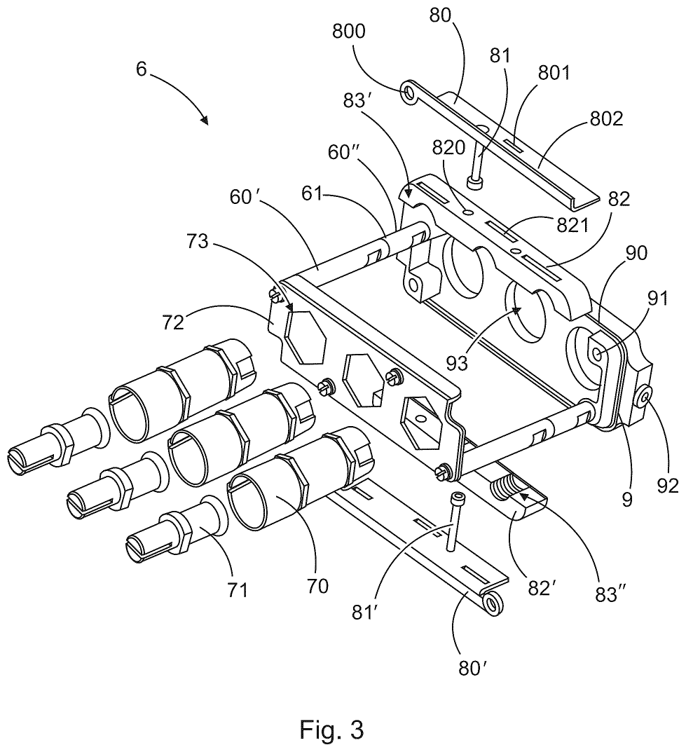

FIG. 2 shows a connector insertion module 6 according to the invention which is inserted, provided with mutually corresponding contact elements 71, both in the plug connector housing 20 and in the mating plug connector housing 30. The combination of a connector insertion module 6 with the plug connector housing 20 forms the plug connector 2. The combination of a second connector insertion module 6, with adapted contact elements 71 corresponding to the contacts of the plug connector 2, with the mating plug connector housing 30 forms the mating plug connector 3. The connector insertion module 6 essentially has a contact region 7, a fixing device 8 and a housing cover 9. The contact region 7 here consists at least of a contact bushing 70, wherein at least one contact element 71 is introduced into the contact bushing 70. The contact element 71 is configured as a slotted pin contact in the embodiment illustrated. It is clear to a person skilled in the art that blade contacts, socket contacts, hermaphrodite contacts and further conceivable contact elements can also be used. The contact bushings 70 are received by a contact mount 72. The contact mount 72 can be configured with at least two parts. It can be seen in the illustration in FIG. 2 and FIG. 3 that the contact mount 72 is configured so that it consists of three components which are connected to one another. This embodiment can entail advantages for the assembly. Following the contact region 7 is a fixing device 8, spaced apart by and connected to at least one distance element 60. An embodiment is shown in which two distance elements 60 are used. The distance elements 60 are here arranged essentially diagonally to each other on the housing cover 9 which is configured as approximately rectangular. The fixing device 8 has at least one conductor bushing 83. The conductor bushing 83 is preferably designed to receive an inner conductor 40 of a line 4.

FIG. 3 shows the connector insertion module 6 shown in FIG. 2 in an exploded illustration. The structure of some elements is clearer here. It is thus readily apparent that at the contact region 7, in addition to the contact bushing 70, the contact element 71 arranged therein and the contact mount 72 retaining the contact bushing 70, a corresponding contact inlet 73 is also provided in the contact bushing 70. The distance element 60 is formed from two distance pieces 62 and 62′ which are connected to each other and has a receiving form 61. Particularly advantageously, a preferred embodiment of the fixing device 8 according to the invention can be seen. The fixing device 8 is here formed from two fixing elements 80 and 80′. Clamping elements 82 and 82′ each are arranged between the fixing elements 80 and 80′. Two connecting elements 81 and 81′ are provided to connect the four abovementioned components to one another. Because the fixing elements 80 and 80′, as well as the clamping elements 82 and 82′, are configured identically, only one of the elements is described in some places below. The fixing element 80 has an opening 800 which enables the connection to the distance element 60. Three engagement forms 801 are formed as slot-like through openings. The fixing element 80 has two connecting openings 802 for clamping the clamping elements 82. The connecting openings 802 overlap in the assembled state with fastening openings 820 of the clamping element 82 to such an extent that the connecting element 81 can be passed at least partially through both openings of the elements. The illustration shows a particularly simple embodiment in which the connecting elements 81 and 81′ are configured as screws with nuts arranged thereon. Each of the connecting elements 81 and 81′ are passed through the connecting openings 802 and the fastening openings 820. By subsequently screwing together the nut and the screw, the fixing elements 80 and 80′ can exert a force on the clamping elements 82 and 82′ such that an inner conductor 40, situated in the conductor bushing 83, of the line 4 is fixed. It is clear in FIG. 3 that the conductor bushing 83 shown in FIG. 2 is formed by the conductor bushing 83′ and 83″ of the respective clamping elements 82 and 82′. Lastly, the housing cover 9 can also be clearly seen. The housing cover 9 shown has a peripheral sealing element 90 which in the assembled state effects a seal with the plug connector housing 20 against foreign media such as dust, dirt and fluids. A fastening form 91 each can be seen in the rounded corners of the housing cover 9. Two fastening forms 91 situated diagonally with respect to each other, are connected to the two distance elements 60 shown, or to the shorter of the distance pieces 62′ shown. The remaining two fastening forms 91 are thus available for the connection of the housing cover 9 to the plug connector housing 2. The embodiment shown of the housing cover 9 also has a connecting form 92 for connection to a mounting rail 5. This connecting form 92 can moreover conceivably be employed for the transmission of a connection to earth or an electromagnetic screen.

Even if different aspects or features of the invention are shown in each case in combination in the figures, it is clear to a person skilled in the art, unless stated otherwise, that the illustrated and discussed combinations are not the only possible ones. In particular, mutually corresponding units or combinations of features from different exemplary embodiments can be exchanged with one another or used individually.

### LIST OF REFERENCE SIGNS

1 plug connector system
2 plug connector
20 plug connector housing
3 mating plug connector
30 mating plug connector housing
4 line
40 inner conductor
41 sheath
42 line fastening
5 mounting rail
6 connector insertion module
60 distance element
61 receiving form
62 distance piece
7 contact region
70 contact bushing
71 contact element
72 contact mount
73 contact inlet
8 fixing device
80 fixing element
800 opening
801 engagement form
802 connecting opening
81 connecting element
82 clamping element
820 fastening opening
821 engagement element
83 conductor bushing
9 housing cover
90 sealing element
91 fastening form
92 connecting form

1. An electrical plug connector for receiving and connecting at least one coaxial line to a mating plug connector, wherein the plug connector has a plug connector housing and a line fastening arranged thereon, wherein the line fastening interacts, to provide a seal against foreign media and to fasten the line, with a sheath, wherein a contact element arranged in the plug connector is electrically conductively connected to an inner conductor of the line and wherein an outer conductor of the line is configured to be electrically conductively connected to the plug connector housing in the interior of the plug connector housing, wherein the inner conductor is received in force-fitting fashion in the interior of the plug connector housing by at least one fixing device.

2. The electrical plug connector according to claim 1, wherein the fixing device has at least one fixing element and one clamping element and the clamping element has at least one conductor bushing.

3. The electrical plug connector according to claim 2, wherein the fixing element has at least one engagement form and the clamping element has at least one engagement element, which are in engagement in the assembled state.

4. The electrical plug connector according to claim 1, wherein the plug connector housing has at least one housing cover which is configured with at least one sealing element to receive at least the line fastening and to protect the plug connector from the penetration of foreign media.

5. The electrical plug connector according to claim 4, wherein the housing cover is configured with at least four fastening forms for fastening to the plug connector and at least one through opening which is configured to receive a line fastening.

6. The electrical plug connector according to claim 4, wherein the housing cover is part of a connector insertion module which furthermore has at least one distance element and one contact region.

7. The electrical plug connector according to claim 6, wherein at least one of the fastening forms is configured for receiving the distance element.

8. The electrical plug connector according to claim 6, wherein the distance element has at least one receiving form which is configured to receive the fixing device.

9. The electrical plug connector according to claim 3, wherein the fixing element has at least one opening which is configured to be brought into engagement with the receiving form of the distance element.

10. The electrical plug connector according to claim 3, wherein the fixing device is formed from at least two essentially identical fixing elements and at least two essentially identical clamping elements, wherein the fixing elements and the clamping elements are connected to one another by at least one connecting element in such a way that a conductor bushing of the clamping element and a conductor bushing of the clamping element receive an inner conductor between them in clamping fashion.

11. The electrical plug connector according to claim 9, wherein the fixing element is arranged on the receiving form so that it can pivot by the opening.

12. The electrical plug connector according to claim 6, wherein the distance element is formed from at least two distance pieces, wherein at least one of the distance pieces has a receiving form.

13. The electrical plug connector according to claim 6, wherein the contact region has a contact bushing, a contact element received by the contact bushing, and a contact mount retaining the contact bushing.

14. An electrical plug connector system for connecting coaxial conductors, consisting of a plug connector and a mating plug connector corresponding therewith, wherein the plug connector has a plug connector housing and the mating plug connector has a mating plug connector housing, wherein the plug connector and the mating plug connector have each at least a fixing device configured for receiving a stripped inner conductor, wherein the fixing devices are arranged in the interior of the plug connector housing and of the mating plug connector housing.

15. The electrical plug connector system according to claim 14, wherein the plug connector and the mating plug connector each have a connector insertion module which are formed from at least one contact region, the fixing device and a housing cover.

16. The electrical plug connector system according to claim 15, wherein the connector insertion module has at least one distance element configured to space the housing cover, the fixing device and the contact region apart from one another.
